(19) United States
(12) Patent Application Publication
(10) Pub. No.: US 2019/0214606 A1
(43) Pub. Date: Jul. 11, 2019

(54) SWITCHABLE BATTERY MODULE

(71) Applicant: Samsung SDI Co., Ltd., Yongin-si (KR)

(72) Inventors: Peter KURCIK, Sankt Nikolai im Sausal (AT); Maximilian HOFER, Hartberg (AT); Helmut HAMMERSCHMIED, Graz (AT); Markus PRETSCHUH, Graz (AT)

(21) Appl. No.: 16/019,220

(22) Filed: Jun. 26, 2018

(30) Foreign Application Priority Data
Jan. 8, 2018 (EP) 18150590.0

(51) Int. Cl. H01M 2/02; H01M 2/04; H01M 10/16; H01M 10/637; H02J 7/00

(52) U.S. Cl. CPC H01M 2/0217; H01M 2/0212; H02J 7/0024; H01M 10/16; H01M 10/637; H01M 2/0473

(57) ABSTRACT

A plurality of battery cells arranged as a cell stack with adjacent lateral walls forming a row includes a case including two lateral walls from among the lateral walls, and a cap assembly capping the case, and including a positive terminal and a negative terminal, and a solid state switch arranged as an element in the cell stack of battery cells and for switchably connect the battery module with an external power grid, the solid state switch including a switch circuit board including a power MOSFET for providing a power stage for performing switching, a back cover and a front cover, the back and front covers forming a housing of the solid state switch and including lateral walls in the same size and shape as the lateral walls of the case of each battery cell.

### CROSS-REFERENCE TO RELATED APPLICATION

This application claims priority to and the benefit of European Patent Application No. 18150590.0 filed in the European Patent Office on Jan. 8, 2018, the entire content of which is incorporated herein by reference.

### FIELD

Aspects of the present invention relate to a switchable battery module and a battery comprising said switchable battery module.

### BACKGROUND

A rechargeable or secondary battery differs from a primary battery in that it can be repeatedly charged and discharged, while the primary battery generally provides an irreversible conversion of chemical to electrical energy. Low-capacity rechargeable batteries may be used as power supplies for small electronic devices, such as cellular phones, notebook computers, and camcorders, while high-capacity rechargeable batteries may be used as power supplies for hybrid vehicles and the like.

In general, rechargeable batteries include an electrode assembly including a positive electrode, a negative electrode, and a separator interposed between the positive and negative electrodes, a case receiving the electrode assembly, and an electrode terminal electrically connected to the electrode assembly. An electrolyte solution is injected into the case in order to enable charging and discharging of the battery via an electrochemical reaction of the positive electrode, the negative electrode, and the electrolyte solution. The shape of the case, which may be cylindrical or rectangular, depends on the battery's intended purpose.

A rechargeable battery may be used as a battery module formed of a plurality of unit battery cells coupled in series and/or in parallel so as to provide a high energy density, for example, for driving the motor of a hybrid vehicle. That is, the battery module is formed by interconnecting the electrode terminals of the plurality of unit battery cells depending on a desired amount of power and in order to realize a high-power rechargeable battery, for example, for an electric vehicle.

Battery modules can be constructed with either a block design or a modular design. In block designs, each battery is coupled to a common current collector structure and a common battery management system, and the unit thereof is housed. In modular designs, pluralities of battery cells are connected to form submodules and several submodules are connected to form the module. The battery management functions can then be at least partially realized on either module or submodule level and thus interchangeability might be improved. One or more battery modules are mechanically and electrically integrated, equipped with a thermal management system, and set up for communication with one or more electrical consumers in order to form a battery system.

To connect/disconnect the battery module from an external power grid (e.g., a battery system power grid/network or a vehicle power grid/network, which may receive electrical power from, or supply electrical power to, the battery module), electromechanical switches (e.g., relays) are typically used for a switching circuit. However, switching circuits based on electromechanical switches may have several disadvantages and may require extra processes to be performed during the production of a battery system. A relay-based electromechanical switch always consumes current when the relay is switched on, which causes continuous power consumption. The mechanical parts of a relay are failure-prone and have only a limited lifetime, that is, the number of switching cycles of a relay is limited. Furthermore, the mechanical switching times are limited due to inertia.

A number of efforts have been made to use power MOSFETs (Metal Oxide Semiconductor Field Effect Transistors) for solid state switches on a circuit board of a battery module. However, due to high operation currents and the non-nominal on-resistance of the switches, power dissipation may be a problem for using MOSFET-based solid state switches. There is thus a special need for efficiently cooling this kind of solid state switches, especially in applications that use high currents. The common approach to cooling the main part of solid state switches in batteries, that is, the switchable MOSFETs, is to use an aluminum heat sink that is thermally connected to the surface of the MOSFETs (e.g. the surface of the individual MOSFET packages). The switching circuit board including the power MOSFETs is then typically connected to a thermal heatsink. To ensure adequate heat transfer from the MOSFETs to the heat sink, thermal interface materials are often used. A major disadvantage of this approach is that the cooling of the solid state switch is independent from the thermal management system used for cooling the individual battery cells in a battery module. Connecting the heat sink to the solid state switch leads to additional expenses in the production of battery modules (e.g. added costs and installation space).

To provide thermal control of a battery system, a thermal management system is required to safely use the battery module by efficiently emitting, discharging and/or dissipating heat generated from its rechargeable batteries. If the heat emission/discharge/dissipation is not sufficiently performed, temperature variations may occur between respective battery cells, such that the battery module cannot generate a desired amount of power. In addition, an increase of the internal temperature can lead to abnormal reactions occurring therein and thus the charging and discharging performance of the rechargeable battery deteriorates and the life-span of the rechargeable battery is shortened. Thus, cell cooling for effectively emitting/discharging/dissipating heat from the cells is desired. For high performance batteries, active cooling systems are often mandatory. Common approaches are to use an active liquid-cooled system or an active air-cooled system. For low performance batteries, passive cooling may be sufficient.

The above information disclosed in this Background section is for enhancement of understanding of the background of the invention and therefore it may contain information that does not constitute prior art.

### SUMMARY

Aspects of the present invention are directed to a battery module including a solid state switch which avoids the requirement of different cooling systems in a battery module while additional expenses in the production of the battery modules are reduced.

According to some embodiments of the present invention, there is provided a plurality of battery cells arranged as a cell stack with adjacent lateral walls forming a row, the lateral walls having uniform size and shape, each of the battery cells including: a case including two lateral walls from among the lateral walls; and a cap assembly configured to cap the case, and including a positive terminal and a negative terminal; and a solid state switch arranged as an element in the cell stack of battery cells and configured to switchably connect the battery module with an external power grid, the solid state switch including: a switch circuit board including a power MOSFET configured to provide a power stage for performing switching, a back cover and a front cover, the back and front covers forming a housing of the solid state switch and including lateral walls in the same size and shape as the lateral walls of the case of each battery cell.

In other words, some embodiments of the present invention provide the solid state switch with the same form factor as a battery cell or a plurality of battery cells; that is, the solid state switch is implemented in a housing that equals or substantially equals, at least in two dimensions, the used battery cell form factor. In some embodiments, the two dimensions are related to the width, depth, and height of a battery cell, of which said two dimensions correspond to the parameters with the largest numerical values (e.g., height and width). In some examples, the front cover and the back cover, as well as the lateral wall of each battery cell, have a uniform or substantially uniform rectangular shape with identical or substantially identical width and height values (i.e., have same or substantially the same form factor). The remaining dimension, that is, the thickness (or depth) of the solid state switch, may be different from the thickness (or depth) of a battery cell in the stack. Having the same form factor allows the integration of the solid state switch (i.e., the housing of the solid state switch) within the stack of battery cells (i.e., the stack of the battery cell cases) such that the same holders can be used for fixing the individual elements to form a common battery module.

Having a solid state switch with the same form factor as a battery cell or a plurality of battery cells offers many desirable effects relative to conventional techniques for the integration of solid state switches (or solid state switching circuits) into battery modules. As the solid state switch is arranged as an additional element in the stack of battery cells, the cooling system of the battery cells can be uses for the solid state switch as well. The same cooling performance can be achieved as for the battery cells, which improves and simplifies the cooling of solid state switches. Additional efforts to cool the MOSFETs of a solid state switch independent from the battery module can thus be avoided. Furthermore, the solid state switch as an additional element in the stack of battery cells can be readily implemented anywhere in the cell stack. This relaxes the build-in situation as the solid state switch and the corresponding heat sink do not require additional installation space in the battery module outside the battery cell stack. The solid state switch is instead arranged with the battery cells in a common installation space. In some examples, the solid state switch is arranged as an element at the end of the battery cell stack. However, embodiments of the present invention are not limited thereto, and the solid state switch can be arranged anywhere on the battery cell stack. It would be also possible to have more than one solid state switch arranged at different positions within a stack of battery cells for distributing the thermal load within the cell stack.

In some embodiments, the maximum power dissipation of the solid state switch is between about 75% and about 125% of the average power dissipation per cell of the plurality of battery cells. Solid state switches for batteries may have an electric resistance of around 1 mΩ. Therefore, power dissipation of P=I²·R is generated. Example values for power dissipation may be 2.5 W at 50 A, 10 W at 100 A, 40 W at 200 A, and 250 W at 500 A. The battery cells or some cells in parallel may have a comparable electrical resistance of 1 mΩ. With the desirable condition that the maximum power dissipation of the solid state switch is between about 75% and about 125% of the average power dissipation per cell of the plurality of battery cells, it is ensured that the maximum power dissipation of the solid state switch and average power dissipation per cell of the plurality of battery cells are roughly within the same range. Being in the same range is important to avoid thermal energy being transferred between the battery cells and the solid state switch. If one of the elements has much higher power dissipation than the other, the thermal imbalance would require an improved cooling to equalize the different thermal potentials. In some examples, the maximum power dissipation of the solid state switch is between about 85% and about 115% of the average power dissipation per cell of the plurality of battery cells. Other exemplary ranges, which may be desired, may be between about 90% and about 110%, between about 90% and about 110%, and between about 95% and about 105%.

In some examples, the average power dissipation per MOSFET in a group of parallel switched power MOSFETs of the solid state switch times the number of parallel switched power MOSFETs is between about 75% and about 125% of the average power dissipation per cell of the plurality of battery cells. Nearly all of the heat dissipation in a solid state switch is caused by the thermal power loss of the power MOSFETs. The power dissipation P=I²·R highly depends on the electrical current that is switched by the MOSFETs. Power dissipation can be reduced by distributing the electrical current over more than one MOSFET. A typical solid state switch thus includes multiple power MOSFETs, which are, for example, electrically connected in parallel to keep the electrical current through a single power MOSFET at a low value. For the design of a solid state switch of the present invention this means that there exists a configuration with a number of parallel MOSFETs in which nearly the same cooling energy is needed for a battery cells (or the totality of battery cells) and the plurality of MOSFETs in the solid state switch. The resulting on-resistance then strongly depends on the number of power MOSFETs, which are switched in parallel. For example, with a typical antiserial back-to-back configuration with 5 MOSFETs in parallel on each side, an overall on-resistance of around 800 μΩ can be achieved. In some examples, the average power dissipation per MOSFET in a group of parallel switched power MOSFETs of the solid state switch times the number of parallel switched power MOSFETs is between about 85% and about 115% of the average power dissipation per cell of the plurality of battery cells. Other exemplary ranges, which may be desired, may be between about 90% and about 110%, between about 90% and about 110%, and between about 95% and about 105%.

In some examples, the solid state switch further includes a gate driver for driving the gate contact of the power MOSFETs, the gate driver including a gate driver board which is different from the switch circuit board. The gate driver board can be integrated within the housing of the solid state switch or it is located outside the housing of the solid state switch, for example, next to, attached to, or even as a part of a cell supervisory circuit (CSC).

In some embodiments, the power MOSFETs are in thermal contact with the back cover and/or the front cover of the solid state switch. This means that the power MOSFETs (e.g. a surface of the package of the MOSFETs) may be at least partly thermally connected to the housing of the solid state switch. The thermal power loss of the MOSFETs is thus transferred to the outside of the solid state switch where it can be cooled by the same cooling system that is used for cooling the battery cells in the battery module. In other examples, the power MOSFETs may be cooled by thermal connection to a liquid cooling system wherein the coolant is channeled through the solid state switch. In this case, a thermal contact between the power MOSFETs and the back cover and/or the front cover of the solid state switch may not be utilized.

In some embodiments, the housing of the solid state switch is identical or substantially identical to a case of a battery cell. In other words, the front cover and the back cover may form a unibody (e.g., a single molded unit) that is identical or substantially identical to the case (cell can) of a battery cell from among the plurality of battery cells.

Moreover, in some embodiments, the switch circuit board may be housed by a full case (including a corresponding cap assembly) which is also used for the case of the battery cells (so-called “switch in a cell can”). This embodiment has the desirable effect that not only the form factor is the same as for the battery cells, but also the electrical connections are simplified compared to the related art, as the same connection techniques for both elements can be applied during module assembling processes. This includes both, high current power connections and low current control connections of the solid state switch. For example, the low current control connections (e.g. for connecting a gate driver to the MOSFETs) may be connect to an external circuit board via conventional wire bonding.

In another exemplary embodiment, the back cover and/or the front cover are formed as a metal block. For example, the metal block may function as an additional heat sink for enhancing the surface for cooling and/or it is applied as a spacer layer to accommodate for varying requirements in the available installation space in different types of battery modules.

In some embodiments, the solid state switch is configured to connect for electrically connecting the switch circuit board with a battery management system, a gate driver board, and/or a cell supervisory circuit (i.e., low current connections). For example, the solid state switch may include a connector, a bonding pad for wire bonding, a ribbon cable, and/or the like.

In some embodiments, the solid state switch includes a first terminal and a second terminal, both terminals being adapted for electrically connecting an external power grid to the plurality of battery cells via the switchable power MOSFETs (i.e., high current connections). The first terminal and a second terminal may be identically formed (or be substantially identical) and arranged like a first terminal and a second terminal of battery cells of the plurality of battery cells. However, the form and arrangement of the terminals of the solid state switch could differ from the form and arrangement of the terminals of the battery cells.

In some embodiments, the plurality of battery cells and the solid state switch are connected in series by busbars via corresponding terminals of the plurality of battery cells and at least one terminal of the solid state switch. Using busbars for interconnecting the individual battery cells of a battery module is well known in the prior art, however, using the same busbars also for connecting the solid state switch to the battery cells allows to reduce the manufacturing costs for cheaper electrical connection of solid state switches. Other types of high current connections (such as high-current cables) are not required during assembling.

In some embodiments, the solid state switch includes an even number of power MOSFETs, each two of the MOSFETs are antiserially connected drain-to-drain or source-to-source. An antiserial connection of power MOSFETs may be used for solid states switches, which allows for a simple and effective circuit design. This type of connection further allows an easy adaption of the heat dissipation to the required amount of heat dissipation in various kinds of battery modules (e.g. 48 V battery modules with different capacities).

In some embodiments, the surfaces of at least some of the power MOSFETs on switch circuit board are thermally connected by a heat spreader (e.g., a heat dissipator), for example, copper inlays or overlays. A heat spreader is a kind of heat exchanger which can be used to equalize heat between multiple heat sources. By connecting at least some of the MOSFETs (e.g. the surface of the individual MOSFET packages) with a common heat spreader, the connection to a cooling system may be simplified and local hotspots in the electronics can be avoided.

In some embodiments, the plurality of battery cells and the solid state switch are cooled by a common heat exchange member. The heat exchange member may be part of the battery module cooling system. Modifications to a conventional heat exchange member may not be required as the common form factor of the solid state switch and the battery cells in the battery module allows the same cooling techniques to be applied to both elements. For example, the heat exchange member of a liquid cooling system may be a heat sink with a number of inner channels for channeling the coolant through the heat exchange member. Therefore, it is desirable for the heat exchange member to be in good thermal contact with the individual heat sources, that is, the battery cells and the solid state switch.

According to another aspect of the present invention, a battery including a battery module as defined above is provided.

According to yet another aspect of the present invention, a vehicle including a battery module as defined above is provided.

Further aspects of the present invention could be learned from the dependent claims or the following description.

### BRIEF DESCRIPTION

Features will become apparent to those of ordinary skill in the art by describing in detail exemplary embodiments with reference to the attached drawings in which:

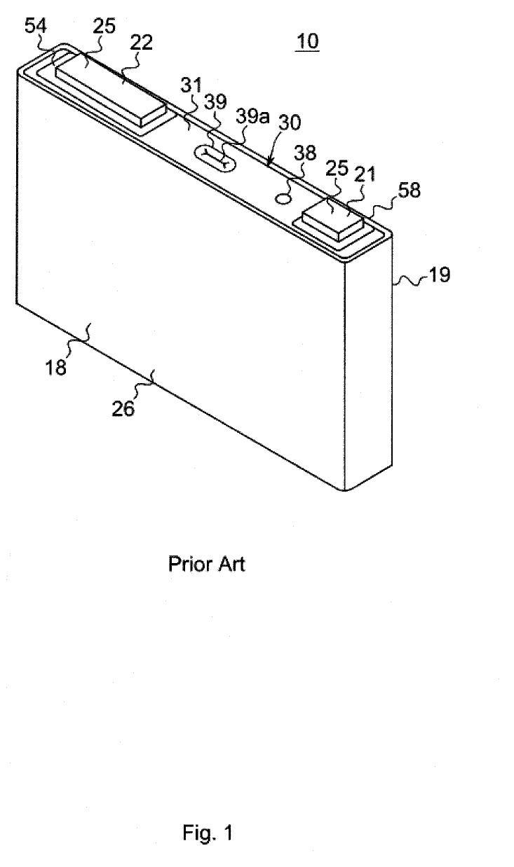

FIG. 1 illustrates a schematic perspective view of a conventional battery cell;

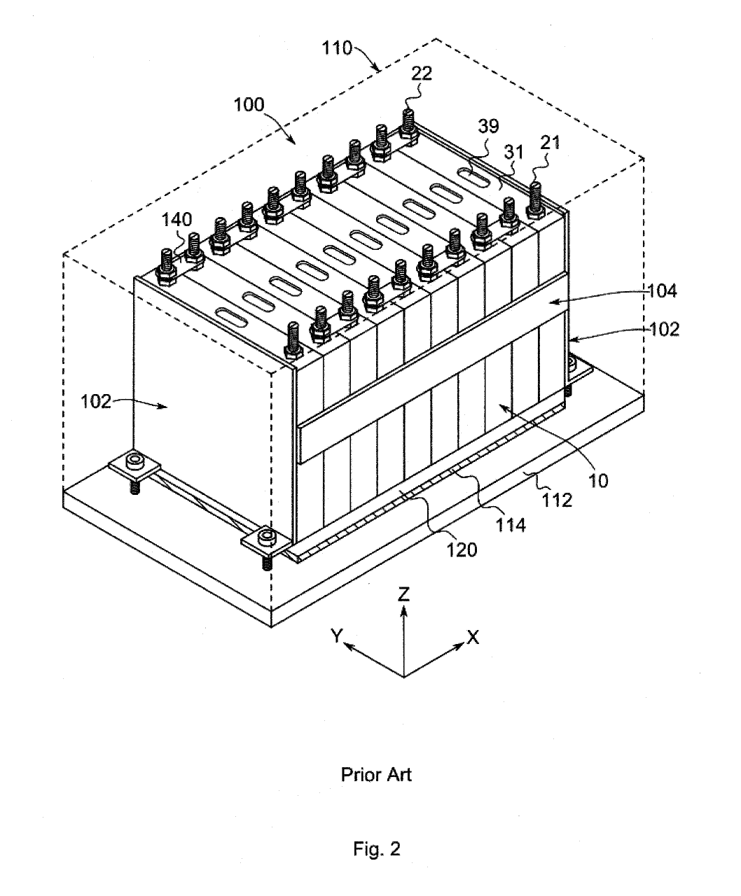

FIG. 2 illustrates a perspective view of a conventional battery module;

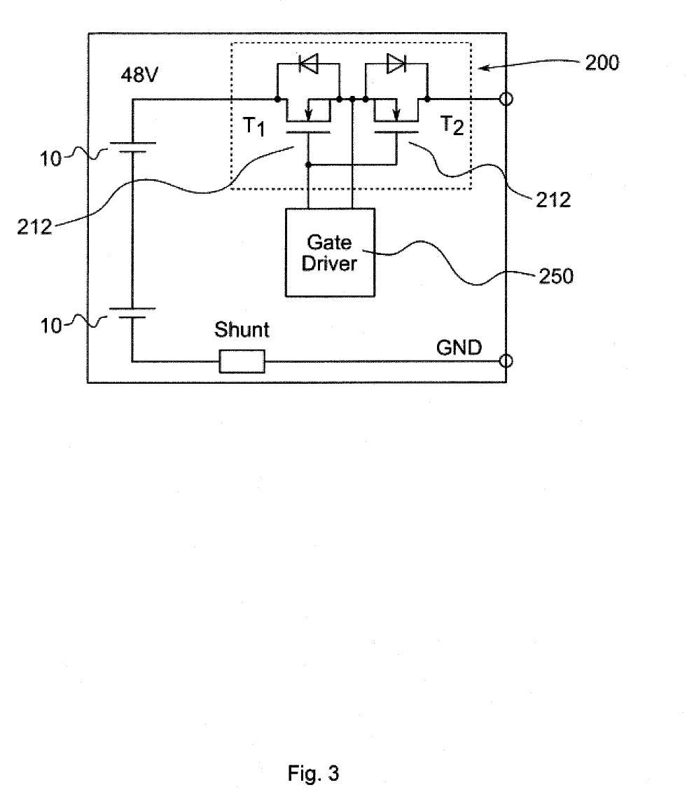

FIG. 3 illustrates a simplified schematic block diagram of a battery module;

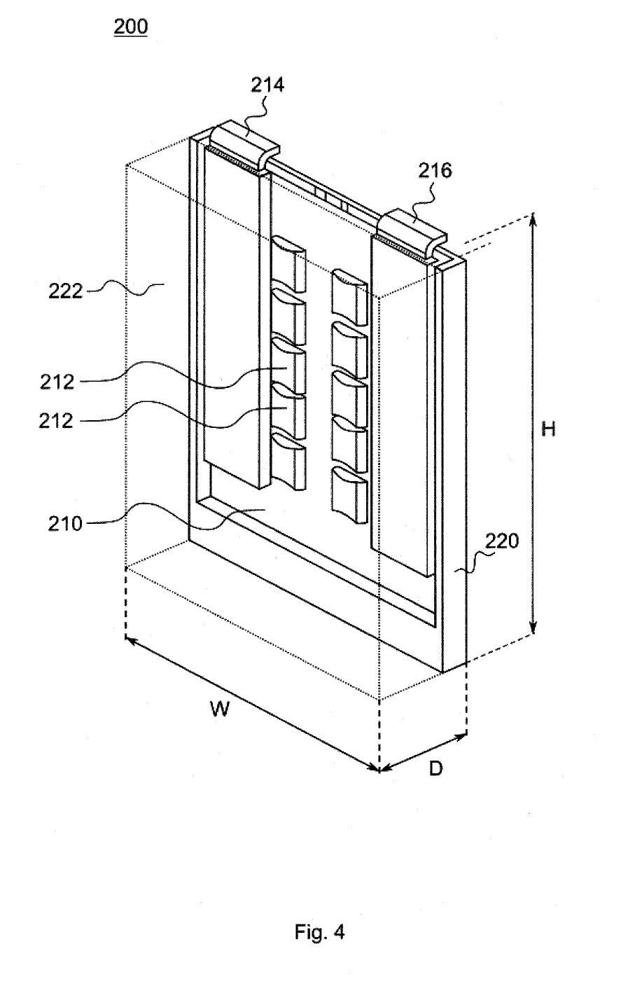

FIG. 4 illustrates a schematic perspective view of a solid state switch according to an exemplary embodiment of the present invention;

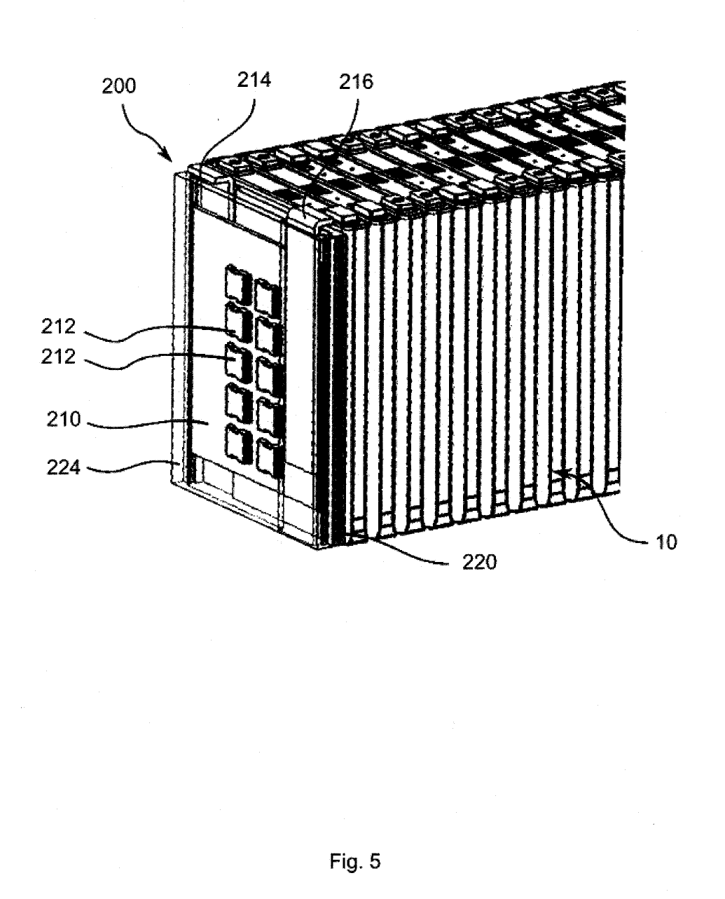

FIG. 5 illustrates a schematic perspective view of a battery module according to an exemplary embodiment of the present invention; and

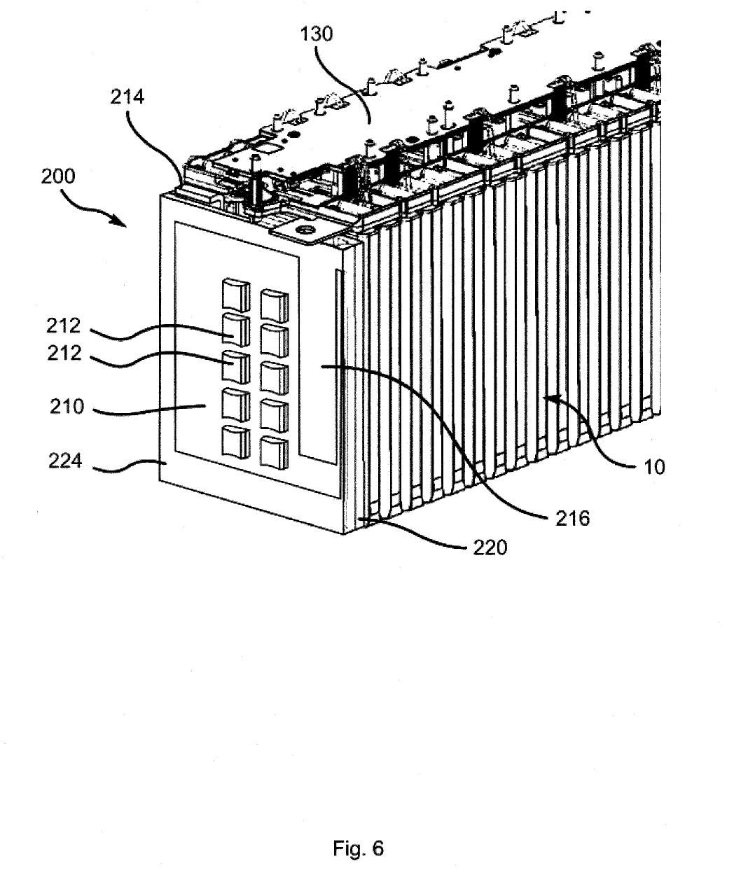

FIG. 6 illustrates a schematic perspective view of a battery module according to an exemplary embodiment of the present invention that includes a battery management system board.

### DETAILED DESCRIPTION

Reference will now be made in detail to embodiments of the present invention, examples of which are illustrated in the accompanying drawings. Aspects and features of the exemplary embodiments, and implementation methods thereof will be described with reference to the accompanying drawings. In the drawings, like reference numerals denote like elements, and, in the following, redundant descriptions may be omitted.

Aspects and features of the inventive concept and methods of accomplishing the same may be understood more readily by reference to the following detailed description of embodiments and the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary for a complete understanding, by those having ordinary skill in the art, of the aspects and features of the present invention may not be described. Unless otherwise noted, like reference numerals denote like elements throughout the attached drawings and the written description, and thus, descriptions thereof will not be repeated.

In the drawings, the sizes of elements may be exaggerated for clarity. For example, in the drawings, the size or thickness of each element may be arbitrarily shown for illustrative purposes, and thus the embodiments of the present invention should not be construed as being limited thereto.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense.

FIG. 1 illustrates a schematic perspective view of a conventional battery cell 10. The battery cell 10 may include an electrode assembly, and a case 26 for accommodating an electrode assembly. The battery cell 10 may also include a cap assembly 30 for sealing (e.g., capping) an opening of the case 26. The battery cell 10 will be described as a non-limiting example of a lithium ion secondary battery configured to have a prismatic (or rectangular) shape.

The case 26 may include a bottom surface having a substantially rectangular shape, and may include a pair of first lateral walls 18 and 19, which are the wide side surfaces, and a pair of second lateral walls, that are narrow side surfaces, connected vertically to end portions of the bottom surface, respectively, to form a space for accommodating the electrode assembly. The first lateral walls 18 and 19 may face each other, and the second lateral walls may be positioned to face each other and may be connected to the first lateral walls 18 and 19. A length of an edge at which the bottom surface and a first lateral wall 18 and 19 are connected to each other may be longer than that of an edge at which the bottom surface and the second lateral wall are connected to each other. In some examples, adjacent first and second lateral walls may form an angle of about 90° therebetween.

The cap assembly 30 may include a cap plate 31 for covering the opening of the case 26 by being bonded to the case 26, and may include a positive terminal 21 (i.e., first terminal) and a negative terminal 22 (i.e., second terminal), which are externally protruded from the cap plate 31 to be electrically connected to a positive electrode and a negative electrode, respectively. The cap plate 31 may be configured to have a shape of a plate that may be extended in one direction, and may be bonded to the opening of the case 26. The cap plate 31 may include an injection hole (or an injection opening) and a vent hole (or a vent opening) that communicate with (e.g., expose) an interior of the cap assembly 30. The injection hole may be configured to allow the injection of the electrolyte solution, and a sealing cap 38 may be mounted thereon or therein. Further, a vent member 39 including a notch 39a, which may be opened due to a set or predetermined pressure may be mounted to or in the vent hole.

The positive terminal 21 and the negative terminal 22 may be mounted to protrude upward from the cap plate 31. A terminal connecting member 25 for electrically connecting the positive terminal 21 may be mounted on the positive terminal 21, and a terminal connecting member 25 for electrically connecting the negative terminal 22 may be mounted on the negative terminal 22.

A gasket for sealing may be mounted between the terminal connecting member 25 and the cap plate 31, while being inserted into the hole (or opening) through which the terminal connecting member 25 may extend. A connecting plate 58 for electrically connecting the positive terminal 21 and the cap plate 31 may be mounted between the positive terminal 21 and the cap plate 31. The terminal connecting member 25 may be inserted into the connecting plate 58. Accordingly, the cap plate 31 and the case 26 may be positively charged.

An upper insulating member 54 for electrically insulating the negative terminal 22 and the cap plate 31 may be mounted between the negative terminal 22 and the cap plate 31. The terminal connecting member 25 may be inserted into a hole (or opening) formed at the upper insulating member 54.

FIG. 2 illustrates a perspective view of a conventional battery module 100. The battery module 100 includes a plurality of battery cells 10 aligned in one direction and a heat exchange member (or a thermal conductor) 120 provided adjacent to a bottom surface of the plurality of battery cells 10. A pair of end plates 102 are provided to face wide surfaces of the battery cells 10 at the outside of the battery cells 10, and a connection plate 104 is configured to connect the pair of end plates 102 to each other thereby fixing the plurality of battery cells 10 together. Fastening portions on both sides of the battery module 100 are fastened to a support plate 112 by bolts. The support plate 112 is part of a housing 110.

Here, each battery cell 10 is a prismatic (or rectangular) cell, the wide flat surfaces of the cells being stacked together to form the battery module 100. Further, each battery cell 10 includes a battery case 26 configured for accommodation of an electrode assembly and an electrolyte. The battery case 26 is sealed (e.g., hermetically sealed) by a cap plate 31. The cap plate 31 is provided with positive and negative terminals (e.g., positive and negative electrode terminals) 21 and 22 having different polarities, and a vent member 39. The vent member 39 is a safety means of the battery cell 10, which acts as a passage through which gas generated in the battery cell 10 is exhausted to the outside of the battery cell 10. The positive and negative terminals 21 and 22 of neighboring battery cells 10 are electrically connected through a bus bar 140, and the bus bar 140 may be fixed by a nut or the like. Hence, the battery module 100 may be used as power source unit by electrically connecting the plurality of battery cells 10 as one bundle.

Generally, the battery cells 10 generate a large amount of heat while being charged/discharged. The generated heat is accumulated in the battery cells 10, thereby accelerating the deterioration of the battery cells 10. Therefore, the battery module 100 further includes a heat exchange member 120, which is provided adjacent to the bottom surface of the battery cells 10 so as to cool down the battery cells 10. In addition, an elastic member 114 made of rubber or other elastic materials may be interposed between the support plate 112 and the heat exchange member 120.

The heat exchange member 120 may include a cooling plate provided to have a size corresponding to that of the bottom surface of the plurality of battery cells 10, for example, the cooling plate may completely overlap the entire bottom surfaces of all the battery cells 10 in the battery module 100. The cooling plate may include a passage through which a coolant can flow. The coolant performs a heat exchange with the battery cells 10 while circulating inside the heat exchange member 120, that is, inside the cooling plate.

FIG. 3 shows a simplified schematic block diagram of a battery module 100, in particular a battery module 100 for a 48 V battery system. The battery cells 10 are connected in series to provide electrical power to an external power grid. For switching the power, a solid state switch 200 including two antiserial connected power MOSFETs 212 (in so-called back-to-back configuration) is integrated in one arm of the circuit. The schematic further shows a gate driver for driving the gate contact of the power MOSFETs 212. The dashed line indicates a specific embodiment, in which the gate driver 250 is placed outside the solid state switch 200, for example, as part of a cell supervisory circuit (CSC) or a battery management system (BMS). Each of the two shown MOSFETs may be representative for a plurality of parallel MOSFETs.

FIG. 4 shows a schematic perspective view of a solid state switch 200 according to an embodiment. The solid state switch 200 includes a switch circuit board 210 having a plurality of power MOSFETs 212 to provide a power stage for performing switching, a back cover 220, for example, for holding the switch circuit board 210, and a front cover 224 in the form of a metal block 222. The back cover 220 and the metal block 222 form the housing of the solid state switch 200. The back cover 220 and the front cover 224 (i.e., metal block 222) may have lateral walls in the same size and shape as the lateral walls 18 and 19 of a case 26 of each battery cell 10 (see, e.g., FIG. 1). The solid state switch (e.g., the housing of the solid state switch), has a prismatic (or rectangular) shape that is defined by the three dimensional values width w, depth d (or thickness), and height h. The form factor of the solid state switch may thus be defined by a width w and a height h, which are identical or substantially identical to the width and height of a battery cell 10 for a battery module 100 of the present invention. The solid state switch can thus be used with a different population (i.e., different number of MOSFETs) in various battery modules that use battery cells with the same form factor. For example, the solid state switch 200 may be used for 48 V batteries with different capacities. The battery cells 10 may have the same or substantially the same form factor, for example, the same or substantially the same width and height as their cases 26, but they could differ in the depth d (or thickness) of the cases 26. The solid state switch can thus be applied to different battery cell 10 formats. The figure also shows a first terminal 214 and a second terminal 216.

FIG. 5 shows a schematic perspective view of a battery module 100 according to an embodiment. The integrated solid state switch 200 basically corresponds to the solid state switch 200 shown in FIG. 4. Thus, reference is made to FIG. 3 for the reference numbers and their assignment. However, in the schematic a front cover 224 similar to the back cover 220 is applied. The housing of the solid state switch 200 may thus be identical or substantially identical to a case 26 of a battery cell 10.

FIG. 6 shows a schematic perspective view of a battery module 100 according to an embodiment that includes a battery management system board 130.

The battery module 100 basically corresponds to the battery module 100 (battery cell 10 stack including a solid state switch 200) shown in FIG. 5. Thus, reference is made to FIG. 5 for the reference numbers and their assignment. However, for 48 V batteries the common approach is to have a battery management system board 130 situated on top of the cell stack, which is shown here for illustration purposes.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “upper”, “lower”, and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A battery module comprising:
a plurality of battery cells arranged as a cell stack with adjacent lateral walls forming a row, the lateral walls having uniform size and shape, each of the battery cells comprising:
a case comprising two lateral walls from among the lateral walls; and
a cap assembly configured to cap the case, and comprising a positive terminal and a negative terminal; and
a solid state switch arranged as an element in the cell stack of battery cells and configured to switchably connect the battery module with an external power grid, the solid state switch comprising:
a switch circuit board comprising a power MOSFET configured to as a power stage for performing switching;
a back cover and a front cover, the back and front covers forming a housing of the solid state switch and comprising lateral walls having a same size and shape as the lateral walls of the case of each battery cell.

2. The battery module of claim 1, wherein a maximum power dissipation of the solid state switch is greater than about 75% of an average power dissipation per cell of the plurality of battery cells.

3. The battery module of claim 1, wherein a maximum power dissipation of the solid state switch is less than about 125% of an average power dissipation per cell of the plurality of battery cells.

4. The battery module of claim 1, wherein an average power dissipation per MOSFET in a group of parallel switched power MOSFETs of the solid state switch times the number of parallel switched power MOSFETs is greater than about 75% of an average power dissipation per cell of the plurality of battery cells.

5. The battery module of claim 1, wherein an average power dissipation per MOSFET in a group of parallel switched power MOSFETs of the solid state switch times the number of parallel switched power MOSFETs is less than about 125% of an average power dissipation per cell of the plurality of battery cells.

6. The battery module of claim 1, further comprising a gate driver configured to drive a gate contact of the power MOSFETs, the gate driver comprising a gate driver board that is different from the switch circuit board.

7. The battery module of claim 1, wherein the power MOSFETs are in thermal contact with the back cover and/or the front cover.

8. The battery module of claim 1, wherein the housing of the solid state switch has identical dimensions as a case of a battery cell of the plurality of battery cells.

9. The battery module of claim 1, wherein the back cover and/or the front cover are formed as a metal block.

10. The battery module of claim 1, wherein the solid state switch is configures to electrically connect the switch circuit board with a battery management system, a gate driver board, and/or a cell supervisory circuit.

11. The battery module of claim 1, wherein the solid state switch comprises a first terminal and a second terminal, the first and second terminals being configured to electrically connect an external power grid to the plurality of battery cells via the power MOSFETs.

12. The battery module of claim 9, wherein the plurality of battery cells and the solid state switch are connected in series by busbars via corresponding terminals of the plurality of battery cells and at least one terminal of the solid state switch.

13. The battery module of claim 1, wherein the solid state switch (200) comprises an even number of power MOSFETs, each pair of the power MOSFETs being antiserially connected drain-to-drain or source-to-source.

14. The battery module of claim 1, wherein surfaces of at least some of the power MOSFETs on the switch circuit board are thermally connected by a heat spreader.

15. The battery module of claim 1, wherein the plurality of battery cells and the solid state switch are cooled by a common thermal conductor.

16. A battery comprising a battery module of claim 1.

17. A vehicle comprising a battery module of claim 1.
